(19) United States
(12) Patent Application Publication
(10) Pub. No.: US 2019/0025639 A1
(43) Pub. Date: Jan. 24, 2019

(54) DISPLAY SUBSTRATE, MANUFACTURING METHOD THEREOF, AND DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Jingjing JIANG, Beijing (CN); Yongzhi SONG, Beijing (CN); Dong WANG, Beijing (CN); Jiyu WAN, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/529,670

(22) PCT Filed: Nov. 8, 2016
(86) PCT No.: PCT/CN2016/105066

§ 371 Date: May 25, 2017

(30) Foreign Application Priority Data
Mar. 24, 2016 (CN) 201610172901.8

(51) Int. Cl. G02F 1/1335

(52) U.S. Cl. CPC G02F 1/133516; G02F 1/133512

(57) ABSTRACT

The present disclosure provides a display substrate, its manufacturing method, and a display apparatus. The display substrate includes a color filter layer and a black matrix. The color filter layer comprises a plurality of color resist units. The black matrix is provided with a plurality of blank regions, each corresponding to one color resist unit. The plurality of color resist units are arranged to align with the plurality of blank regions such that an orthographic projection of each color resist unit on the black matrix partially overlaps with at least one blank region to thereby form at least one gap in the at least one blank region clear of the orthographic projection of the each color resist unit.

### CROSS-REFERENCE TO RELATED APPLICATION

The present application claims priority to Chinese Patent Application No. 201610172901.8 filed on Mar. 24, 2016, the disclosure of which is hereby incorporated by reference in its entirety.

### TECHNICAL FIELD

The present disclosure relates generally to display technologies, and more specifically to a display substrate, its manufacturing method, and a display apparatus containing the display substrate.

### BACKGROUND

With the rapid development of display technologies, liquid crystal display devices have been more and more widely used. A color film substrate is an important component of a liquid crystal display device, which can include a black matrix and sequentially arranged red color resist units R, green color resist units G, and blue color resist units B.

In order to improve the transmission ratio of the liquid crystal display device, a white color filter layer W is typically added in the color film substrate. However, these existing technologies have the following issues: 1) if the white color filter layer W is directly added, an additional production line is needed, i.e. an additional fabrication process is needed, thereby increasing the cost for equipment; 2) if a thick passivation layer is employed as the white color filter layer W, the cost for materials is increased. As such, these existing technologies result in an increased manufacturing cost.

### SUMMARY

The present disclosure provides a display substrate, its manufacturing method, and a display apparatus.

In a first aspect, a display substrate is disclosed. The display substrate includes a color filter layer and a black matrix. The color filter layer comprises a plurality of color resist units. The black matrix is provided with a plurality of blank regions, each corresponding to one color resist unit. The plurality of color resist units are arranged to align with the plurality of blank regions such that an orthographic projection of each color resist unit on the black matrix partially overlaps with at least one blank region to thereby form at least one gap in the at least one blank region clear of the orthographic projection of the each color resist unit.

The display substrate can further include a substrate plate, disposed such that the black matrix is sandwiched between the substrate plate and the color filter layer.

In some embodiments of the display substrate, each of the at least one gap has a width configured to allow transmission of a white light emitted from a backlight therethrough without being recognized by human eyes. In a display substrate as such, each of the at least one gap can have a width less than 10 μm.

In some embodiments of the display substrate, the plurality of blank regions of the black matrix are arranged in a matrix of rows and columns. The plurality of color resist units can comprise a plurality of red color resist units, a plurality of green color resist units, and a plurality of blue color resist units, configured such that a red color resist unit, a green color resist unit, and a blue color resist unit are sequentially arranged in sets in any of the rows of blank regions. Other configurations are also possible, and thus there are no limitations herein.

In a display substrate according to some embodiments of the present disclosure, each of the plurality of color resist units can be configured to extend in a direction of the columns to at least cover a portion of the black matrix between two adjacent blank regions in any column. In some of these above embodiments, each of the plurality of color resist units can be configured to cover a column of blank regions.

In a display substrate according to some other embodiments of the present disclosure, the plurality of color resist units are arranged in the matrix of rows and columns and correspond to the plurality of blank regions in a one-to-one relationship. In some of these above embodiments, a gap can be arranged between each color resist unit and each edge of a corresponding blank region.

The display substrate can further include a protection layer, which can be disposed over a side of the color filter layer opposing to the black matrix.

Additionally, the display substrate can further include a transparent conductive layer, which can be disposed over a side of the substrate plate opposing to the black matrix, or can be disposed over a side of the protection layer opposing to the color filter layer.

In the display substrate as described above, the transparent conductive layer can comprise ITO (indium tin oxide).

In a second aspect, the present disclosure further provides a display apparatus, which comprises a display substrate according to any of the embodiments as described above.

The display apparatus can further include a backlight, which can be disposed over a side of the black matrix opposing to the color filter layer, and is configured to emit a white light.

In a third aspect of the present disclosure, a method for manufacturing a display substrate as described above is provided. The method comprises the following steps:

forming a black matrix over a substrate plate, wherein the black matrix is provided with a plurality of blank regions; and

forming a color filter layer comprising a plurality of color resist units over the black matrix, wherein the plurality of color resist units are arranged to align with the plurality of blank regions such that an orthographic projection of each color resist unit on the black matrix partially overlaps with at least one blank region to thereby form at least one gap in the at least one blank region clear of the orthographic projection of the each color resist unit.

According to some embodiments of the present disclosure, after forming a color filter layer comprising a plurality of color resist units over the black matrix, the method can further include: forming a protection layer over the color filter layer.

According to some embodiments of the method, prior to forming a black matrix over a substrate plate, the method can further include: forming a transparent conductive layer over a side of the substrate plate opposing to the black matrix.

According to some embodiments of the present disclosure, after forming a color filter layer comprising a plurality of color resist units over the black matrix, the method can further include: forming a transparent conductive layer over the protection layer.

In the method as described above, the transparent conductive layer can comprise ITO (indium tin oxide).

Other embodiments may become apparent in view of the following descriptions and the attached drawings.

### BRIEF DESCRIPTION OF THE DRAWINGS

To more clearly illustrate some of the embodiments, the following is a brief description of the drawings. The drawings in the following descriptions are only illustrative of some embodiments. For those of ordinary skill in the art, other drawings of other embodiments can become apparent based on these drawings.

FIG. 1 is a schematic diagram of the structure of a display substrate according to a first embodiment of the disclosure;

FIG. 2 is a schematic diagram of the blank regions of the black matrix as shown in FIG. 1;

FIG. 3 is a schematic diagram of the structure of a display substrate according to a second embodiment of the disclosure;

FIG. 4 is a schematic diagram of the blank regions of the black matrix as shown in FIG. 3;

FIG. 5 is a flow chart of a method for manufacturing a display substrate according to some embodiments of the disclosure.

### DETAILED DESCRIPTION

In the following, with reference to the drawings of various embodiments disclosed herein, the technical solutions of the embodiments of the disclosure will be described in a clear and fully understandable way. It is obvious that the described embodiments are merely a portion but not all of the embodiments of the disclosure. Based on the described embodiments of the disclosure, those ordinarily skilled in the art can obtain other embodiment(s), which come(s) within the scope sought for protection by the disclosure.

In order to address the cost issue associated with current liquid crystal display technologies, the present disclosure provides a display substrate, its manufacturing method, and a display apparatus containing the display substrate.

The display substrate comprises a color filter layer and a black matrix, wherein the color filter layer is disposed over one side of the black matrix. The color filter layer includes a plurality of color resist units; and the black matrix is provided with a plurality of blank regions. The plurality of color resist units are arranged to align with the plurality of blank regions in a corresponding manner, and at least one gap is arranged between at least one edge of each blank region and one corresponding color resist unit. The display substrate can further include a substrate plate, and the black matrix can be sandwiched between the substrate plate and the color filter layer.

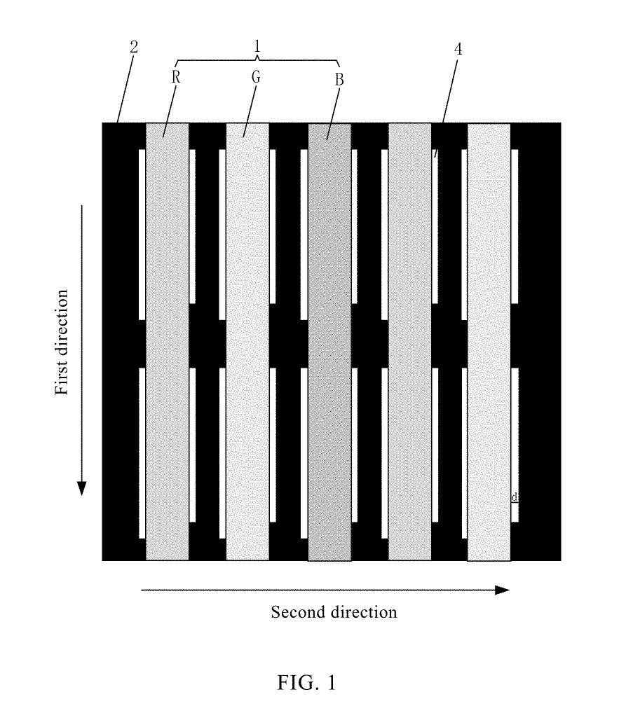

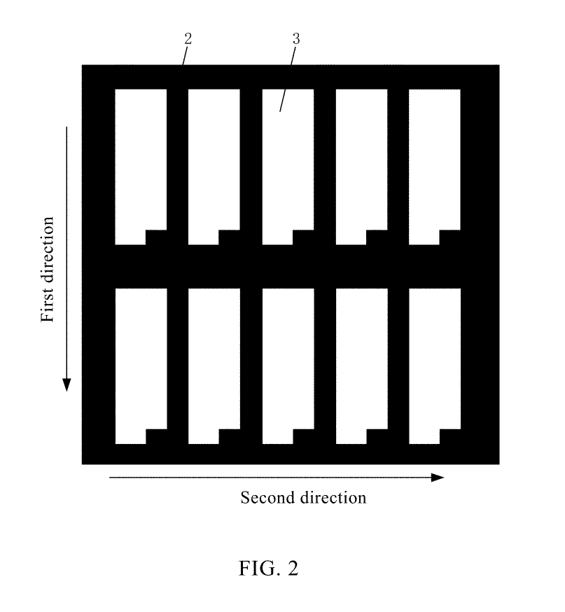

FIG. 1 illustrates the structure of a display substrate according to a first embodiment of the disclosure, and FIG. 2 is a schematic diagram of the blank regions as shown in FIG. 1. As shown in FIG. 1 and FIG. 2, the display substrate includes a substrate plate, a color filter layer 1, and a black matrix 2, wherein the color filter layer 1 comprises a plurality of color resist units, and the color filter layer 1 and the black matrix 2 are disposed over the substrate plate.

The black matrix 2 is provided with a plurality of blank regions 3, configured to align with the plurality of color resist units in the color filter layer 1 in a corresponding manner. Gaps 4 are arranged between each color resist unit and edges of each blank region.

The gaps 4 in the display substrate as disclosed herein serve the role of a white color filter layer W: the gaps 4 are configured for light transmission, and specifically for the transmission of the white light emitted from the backlight.

In this embodiment, the substrate plate (not shown in FIG. 1) is disposed below the color filter layer 1 and the black matrix 2. In some embodiment, the black matrix 2 is disposed over the substrate plate, and the color filter layer 1 is disposed over the black matrix 2.

The color filter layer 1 is disposed over the substrate plate. The plurality of color resist units in the color filter layer 1 include a plurality of red color resist units, a plurality of green color resist units, and a plurality of blue color resist units. In the color filter layer 1, the plurality of color resist units are sequentially arranged in order of a red color resist unit, a green color resist unit, and a blue color resist unit.

As shown in FIG. 2, the plurality of blank regions 3 are arranged in a matrix, and each blank region 3 corresponds to a pixel unit.

The plurality of color resist units in the color filter layer 1 each extends in a first direction and are sequentially aligned in a second direction. The first direction and the second direction crosses to each other, and in some preferred embodiment, the first direction and the second direction are perpendicular to each other.

In FIG. 1, the first direction is in a column direction and the second direction is in a row direction. As such, the plurality of color resist units in the color filter layer 1 are arranged in columns and each color resist unit takes one column.

In the second direction, a gap 4 is arranged between each color resist unit and each of the two edges of a corresponding blank region 3. As such, each color resist unit corresponds to multiple blank regions 3, and thus also corresponds to multiple pixel units.

In the first embodiment, because the blank regions 3 of the black matrix 2 are not continuous in the first direction, the plurality of color resist units in the color filter layer 1 cover portions of the black matrix 2 between adjacent blank regions 3 in the first direction.

In the embodiment, each gap 4 is configured to have a width d, where 0 μm<d<10 μm. This ensures that human eyes cannot recognize the existence of white light, and can only see the colorful dots due to the mixture of the transmitted white light with the filtered light after the white light passes through any of the red color resist units, the green color resist units, and the blue color resist units.

In some embodiments, the display substrate can further include a protection layer, disposed over the color filter layer 1. The protection layer is not shown in the drawings.

In some embodiments, the display substrate can further include a spacer, disposed over the protection layer. The spacer is not shown in the drawings.

In some embodiments, the display substrate can further include a transparent conductive layer, disposed on a side of the substrate plate opposing to the black matrix 2. In some other embodiments, if the display apparatus is a twisted nematic (TN) display apparatus, the transparent conductive layer can be disposed over the protection layer. The transparent conductive layer can comprise ITO (indium tin oxide), and is not shown in the drawings.

In the embodiments of the display substrate as described above, the black matrix is provided with a plurality of blank regions, and gaps are arranged between each color resist unit of the color filter layer and the edges of the corresponding blank region. Each gap is configured for transmission of the white light, and as such, the issue of increased equipment cost due to the direct addition of white color resist units, and the issue of increased material cost due to the employment of a thick passivation layer as the white color filter layer, can be avoided, thereby resulting in a reduced manufacturing cost. Additionally, the issue of different heights among pixels commonly caused by the use of a thick passivation layer as the white color filter layer can also be avoided.

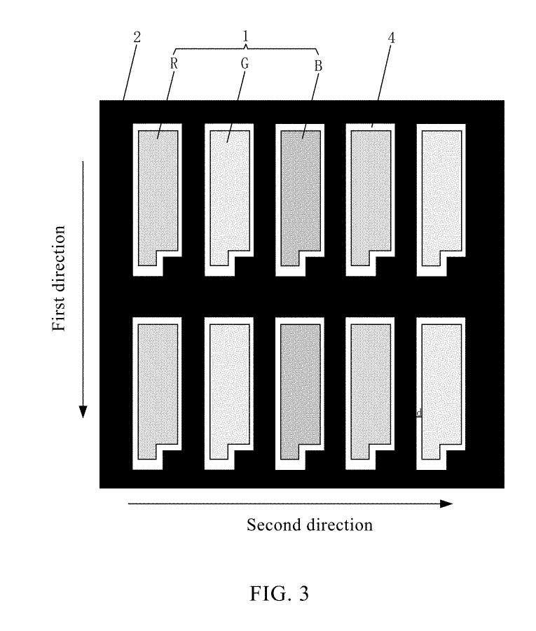

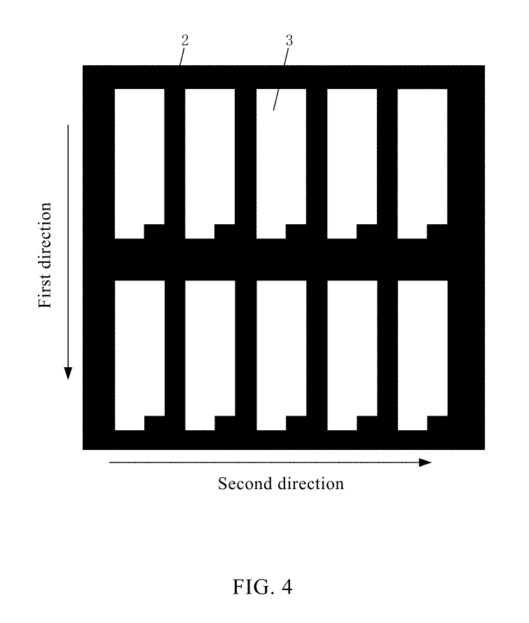

FIG. 3 illustrates the structure of a display substrate according to a second embodiment of the disclosure, and FIG. 4 is a schematic diagram of the blank regions as shown in FIG. 3. As shown in FIG. 3 and FIG. 4, the display substrate includes a substrate plate, a color filter layer 1, and a black matrix 2, wherein the color filter layer 1 comprises a plurality of color resist units, and the color filter layer 1 and the black matrix 2 are disposed over the substrate plate.

The black matrix 2 is provided with a plurality of blank regions 3. The plurality of blank regions are configured to align with the plurality of color resist units in the color filter layer 1 in a corresponding manner. Gaps 4 are arranged between each color resist unit and edges of each blank region.

The gaps 4 in the display substrate as disclosed herein serve the role of a white color filter layer W: the gaps 4 are configured for light transmission, and specifically for the transmission of the white light emitted from the backlight source.

In this second embodiment, the substrate plate (not shown in FIG. 1) is disposed below the color filter layer 1 and the black matrix 2. In some embodiment, the black matrix 2 is disposed over the substrate plate, and the color filter layer 1 is disposed over the black matrix 2.

The color filter layer 1 is disposed over the substrate plate. The plurality of color resist units in the color filter layer 1 include a plurality of red color resist units, a plurality of green color resist units, and a plurality of blue color resist units. In the color filter layer 1, the plurality of color resist units are sequentially arranged in order of a red color resist unit, a green color resist unit, and a blue color resist unit.

As shown in FIG. 4, the plurality of blank regions 3 are arranged in a matrix, and each blank region 3 corresponds to a pixel unit.

The plurality of color resist units in the color filter layer 1 are arranged in a matrix, and gaps 4 are arranged between each color resist unit and edges of each corresponding blank region 3 in multiple directions. As such, each color resist unit corresponds to a blank region 3, and it is configured that no overlapping region exists between each color resist unit and its corresponding blank region 3.

Each color resist unit corresponds to a blank region 3, and thus also corresponds to a pixel unit. In this second embodiment of the display substrate, because gaps 4 are arranged between each color resist unit and edges of each corresponding blank region 3 in multiple directions, thus resulting in a higher transmission ratio compared with the first embodiment of the display substrate.

In the embodiment, each gap 4 is configured to have a width d, where 0 μm<d<10 μm.

In some embodiments, the display substrate can further include a protection layer, disposed over the color filter layer 1. The protection layer is not shown in the drawings.

In some embodiments, the display substrate can further include a spacer, disposed over the protection layer. The spacer can optionally have a shape of pillar. The spacer is not shown in the drawings.

In some embodiments, the display substrate can further include a transparent conductive layer, disposed on a side of the substrate plate opposing to the black matrix 2. In some other embodiments, if the display apparatus is a twisted nematic (TN) display apparatus, the transparent conductive layer can be disposed over the protection layer. The transparent conductive layer can comprise ITO, and is not shown in the drawings.

In the embodiments of the display substrate as described above, the black matrix is provided with a plurality of blank regions, and gaps are arranged between each color resist unit of the color filter layer and the edges of the corresponding blank region. Each gap is configured for transmission of the white light, and as such, the issue of increased equipment cost due to the direct addition of white color resist units, and the issue of increased material cost due to the employment of a thick passivation layer as the white color filter layer, can be avoided, thereby resulting in a reduced manufacturing cost. Additionally, the issue of different heights among pixels commonly caused by the use of a thick passivation layer as the white color filter layer can also be avoided. Furthermore, the arrangement of gaps as described in the above embodiments can increase the transmission ratio of the display substrate without altering the structure of the pixels or changing the manner of driving.

In another aspect, this present disclosure further provides a display apparatus. The display apparatus includes a display substrate, and an opposite substrate, disposed to be opposed to the display substrate. The display substrate can be based on the first embodiment or the second embodiment as described above.

In some embodiments, the opposite substrate can be an array substrate, and the display substrate can be a color film substrate.

The display apparatus disclosed herein can further comprise a backlight, wherein the backlight emits white light.

In the embodiments of the display apparatus as described above, the black matrix is provided with a plurality of blank regions, and gaps are arranged between each color resist unit of the color filter layer and the edges of the corresponding blank region. Each gap is configured for transmission of the white light, and as such, the issue of increased equipment cost due to the direct addition of white color resist units, and the issue of increased material cost due to the employment of a thick passivation layer as the white color filter layer, can be avoided, thereby resulting in a reduced manufacturing cost. Additionally, the issue of different heights among pixels commonly caused by the use of a thick passivation layer as the white color filter layer can also be avoided. Furthermore, the arrangement of gaps as described in the above embodiment can increase the transmission ratio of the display substrate of the display apparatus without altering the structure of the pixels or changing the manner of driving.

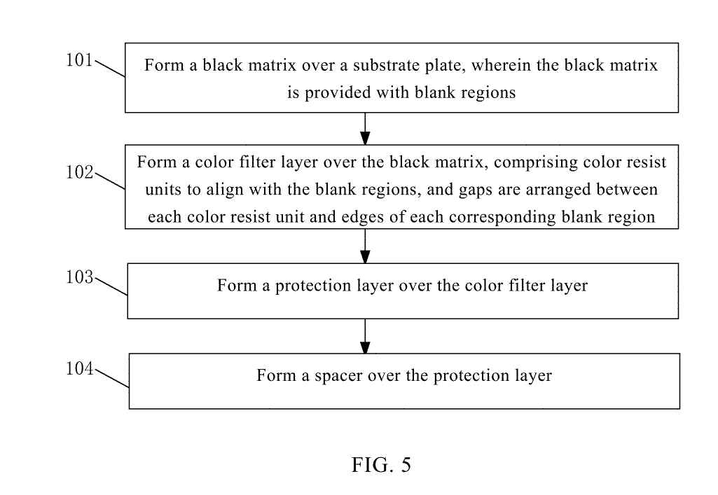

In yet another aspect, this present disclosure further provides a method for manufacturing a display substrate. A flow chart of a manufacturing method according to some embodiments of the disclosure is illustrated in FIG. 5. The method comprises:

Step 101: forming a black matrix over a substrate plate, wherein the black matrix is provided with a plurality of blank regions;

Step 102: forming a color filter layer comprising a plurality of color resist units over the black matrix, wherein the plurality of color resist units are configured to align with the plurality of blank regions in a corresponding manner, and at least one gap is arranged between each color resist unit and an edge of each corresponding blank region;

Step 103: forming a protection layer over the color filter layer; and

Step 104: forming a spacer over the protection layer.

As illustrated in FIG. 2 and FIG. 4, the black matrix 2 is formed over a first side of the substrate plate, and the black matrix 2 is provided with a plurality of blank regions 3. Herein the first side of the substrate plate refers to the side of the substrate plate that is close to the opposite substrate.

As illustrated in FIG. 1, the plurality of color resist units in the color filter layer can include a plurality of red color resist units (R), a plurality of green color resist units (G), and a plurality of blue color resist units (B). The plurality of color resist units are sequentially arranged over the black matrix in order of a red color resist unit, a green color resist unit, and a blue color resist unit.

The plurality of color resist units in the color filter layer 1 each extends in a first direction and are sequentially aligned in a second direction, wherein the first direction and the second direction crosses to each other. A gap 4 is arranged between each color resist unit and each edge of a corresponding blank region 3 in the second direction.

Alternatively as shown in FIG. 2, the plurality of color resist units in the color filter layer 1 can include a plurality of red color resist units (R), a plurality of green color resist units (G), and a plurality of blue color resist units (B). The plurality of color resist units are sequentially arranged over the black matrix in order of a red color resist unit, a green color resist unit, and a blue color resist unit. The plurality of color resist units in the color filter layer 1 are arranged in a matrix, and gaps 4 are arranged between each color resist unit and edges of each corresponding blank region 3 in multiple directions.

In the embodiment, each gap 4 is configured to have a width d, where 0 μm<d<10 μm. In some embodiments, the spacer can have a shape of pillar.

Prior to Step 101, the method for manufacturing a display substrate can further comprise a step 100: forming a transparent conductive layer over a second side of the substrate plate opposing to the black matrix. Herein the second side is opposing to the first side of the substrate plate.

If the display apparatus is a twisted nematic (TN) display apparatus, the transparent conductive layer is disposed over the protection layer. As such, the method for manufacturing a display substrate can, after Step 103, further comprise a step of forming a transparent conductive layer over the protection layer. The transparent conductive layer can comprise ITO.

It is noted that the protection layer, the spacer and the transparent conductive layer are not shown in the drawings.

The method for manufacturing a display substrate as described above can be employed to manufacture a display substrate according to the first embodiment or the second embodiment. Details of the first embodiment and the second embodiment can be referenced above.

In the embodiments of a method for manufacturing a display substrate as described above, the black matrix is provided with a plurality of blank regions, and gaps are arranged between each color resist unit of the color filter layer and the edges of the corresponding blank region. Each gap is configured for transmission of the white light, and as such, the issue of increased equipment cost due to the direct addition of white color resist units, and the issue of increased material cost due to the employment of a thick passivation layer as the white color filter layer, can be avoided, thereby resulting in a reduced manufacturing cost. Additionally, the issue of different heights among pixels commonly caused by the use of a thick passivation layer as the white color filter layer can also be avoided. Furthermore, the arrangement of gaps as described in the above embodiment can increase the transmission ratio of the display substrate of the display apparatus without altering the structure of the pixels or changing the manner of driving.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A display substrate, comprising:
a color filter layer, comprising a plurality of color resist units;
a black matrix, having a plurality of blank regions, each corresponding to one color resist unit;
wherein:
the plurality of color resist units are arranged to align with the plurality of blank regions such that an orthographic projection of each color resist unit on the black matrix partially overlaps with at least one blank region to thereby form at least one gap in the at least one blank region clear of the orthographic projection of the each color resist unit.

2. The display substrate according to claim 1, further comprising a substrate plate, wherein the black matrix is sandwiched between the substrate plate and the color filter layer.

3. The display substrate according to claim 1, wherein each of the at least one gap has a width configured to allow transmission of a white light emitted from a backlight therethrough without being recognized by human eyes.

4. The display substrate according to claim 3, wherein each of the at least one gap has a width less than 10 μm.

5. The display substrate according to claim 4, wherein:
the plurality of blank regions of the black matrix are arranged in a matrix of rows and columns; and
the plurality of color resist units comprise a plurality of red color resist units, a plurality of green color resist units, and a plurality of blue color resist units, configured such that a red color resist unit, a green color resist unit, and a blue color resist unit are sequentially arranged in sets in any of the rows of blank regions.

6. The display substrate according to claim 5, wherein each of the plurality of color resist units is configured to extend in a direction of the columns to at least cover a portion of the black matrix between two adjacent blank regions in any column.

7. The display substrate according to claim 6, wherein each of the plurality of color resist units is configured to cover a column of blank regions.

8. The display substrate according to claim 5, wherein the plurality of color resist units are arranged in the matrix of rows and columns and correspond to the plurality of blank regions in a one-to-one relationship.

9. The display substrate according to claim 8, wherein a gap is arranged between each color resist unit and each edge of a corresponding blank region.

10. The display substrate according to claim 2, further comprising a protection layer, wherein the protection layer is disposed over a side of the color filter layer opposing to the black matrix.

11. The display substrate according to claim 10, further comprising a transparent conductive layer, disposed over a side of the substrate plate opposing to the black matrix.

12. The display substrate according to claim 10, further comprising a transparent conductive layer, disposed over a side of the protection layer opposing to the color filter layer.

13. The display substrate according to claim 11, wherein the transparent conductive layer comprises ITO (indium tin oxide).

14. A display apparatus, comprising a display substrate according to claim 1.

15. The display apparatus of claim 14, further comprising a backlight, disposed over a side of the black matrix opposing to the color filter layer, and configured to emit a white light.

16. A method for manufacturing a display substrate, comprising:
forming a black matrix over a substrate plate, wherein the black matrix is provided with a plurality of blank regions; and
forming a color filter layer comprising a plurality of color resist units over the black matrix, wherein the plurality of color resist units are arranged to align with the plurality of blank regions such that an orthographic projection of each color resist unit on the black matrix partially overlaps with at least one blank region to thereby form at least one gap in the at least one blank region clear of the orthographic projection of the each color resist unit.

17. The method of claim 16, further comprising, after forming a color filter layer comprising a plurality of color resist units over the black matrix:
forming a protection layer over the color filter layer.

18. The method of claim 17, further comprising, prior to forming a black matrix over a substrate plate:
forming a transparent conductive layer over a side of the substrate plate opposing to the black matrix.

19. The method of claim 17, further comprising, after forming a color filter layer comprising a plurality of color resist units over the black matrix:
forming a transparent conductive layer over the protection layer.

20. The display substrate according to claim 12, wherein the transparent conductive layer comprises ITO (indium tin oxide).
